(19) United States
(12) Patent Application Publication
(10) Pub. No.: US 2003/0004799 A1
(43) Pub. Date: Jan. 2, 2003

(54) Enhancement incentive system using transaction events for users rewards on a distributed network

(76) Inventor: William Elmer Kish, Moraga, CA (US)

Correspondence Address: WILLIAM E. KISH, 1738 St. Andrews Drive, Moraga, CA, 94556, US

(21) Appl. No.: 09/898,686

(22) Filed: Jul. 2, 2001

(51) Int. Cl. G06F 17/60

(52) U.S. Cl. 705/14

(57) ABSTRACT

An Integrated Service System (ISS) providing infrastructure for employee empowerment and customer incentive. The accumulation of earned points and converted points to equity with the accordance to a subscription purchase agreement. The ISS includes an employee account with the legal owner of the work hour, work shift, point and equity. The employee and the customer have in their respective contract specific sets of employment terms, customer terms and employment or customer conditions related to shifts worked, hours worked, points earned by specific sponsored programs and service or product purchases. The ISS provides the modules and databases for the employee to increase his or her points and points for conversion to equity in the business by servicing, marketing, selling and benefiting and to convert those points from productivity gains as reflected in the business Unit and Company Databases. The Internet is used for execution in servicing, marketing, selling which results in empowerment and increasing value for the employee and the customer.

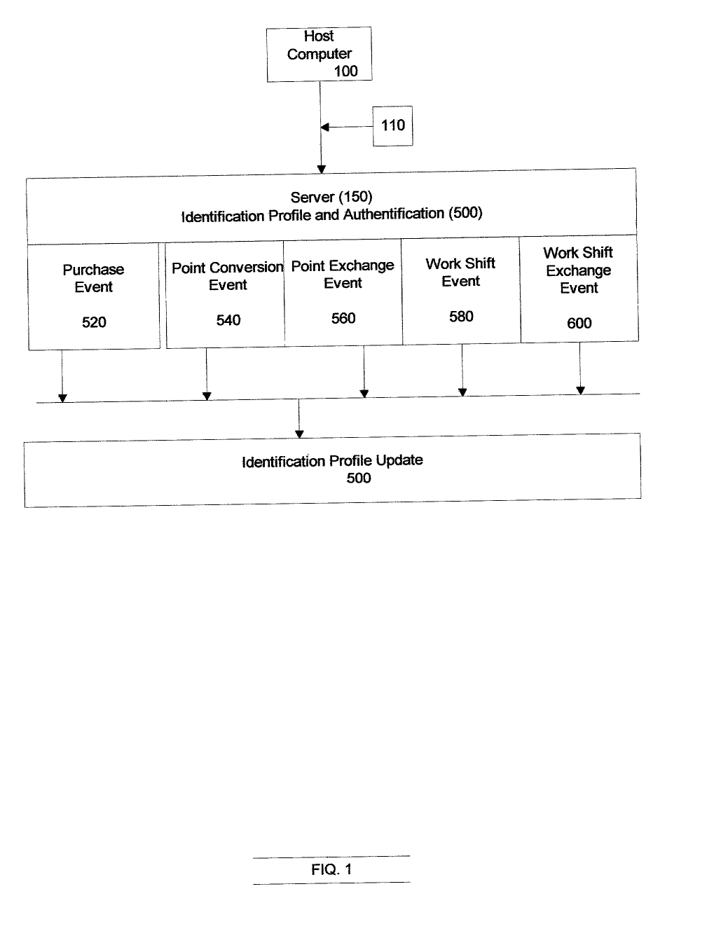

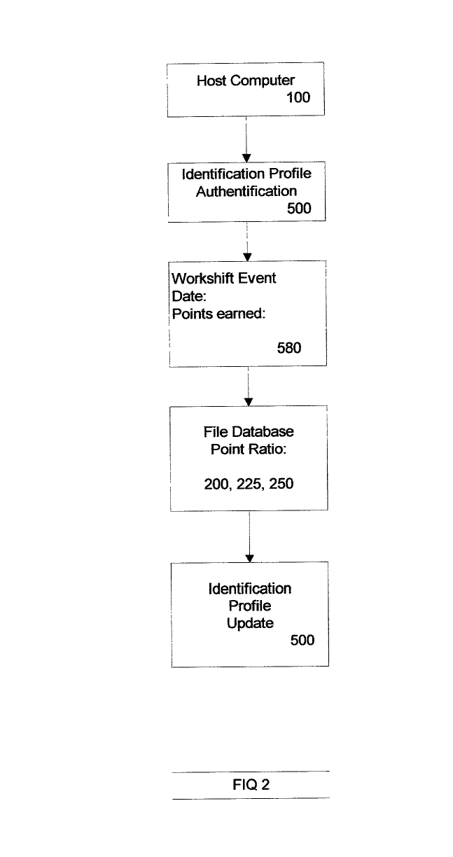

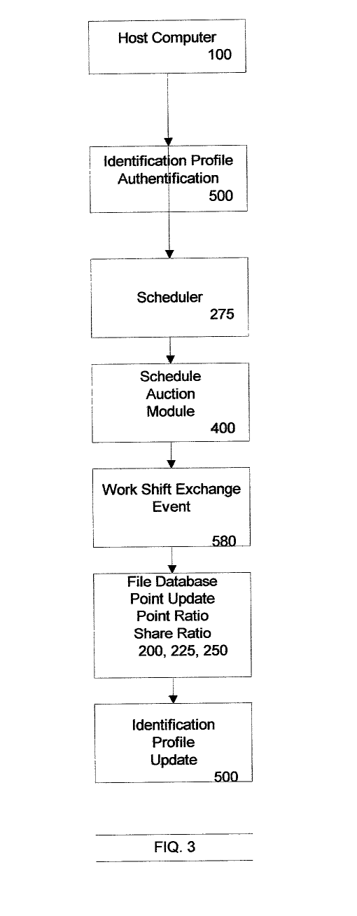

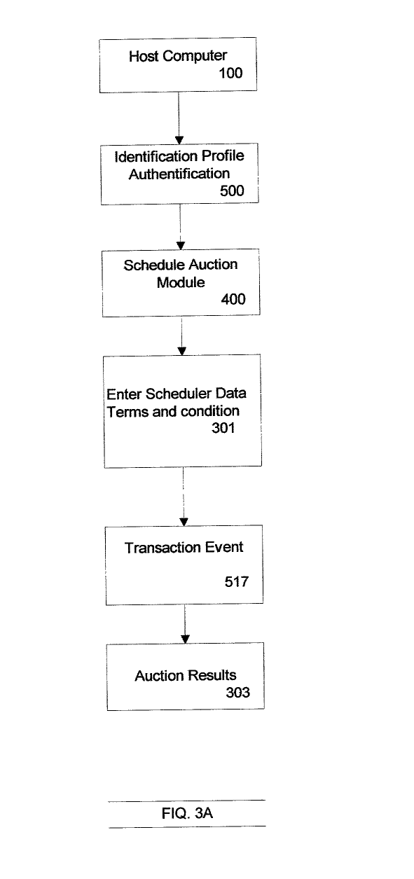

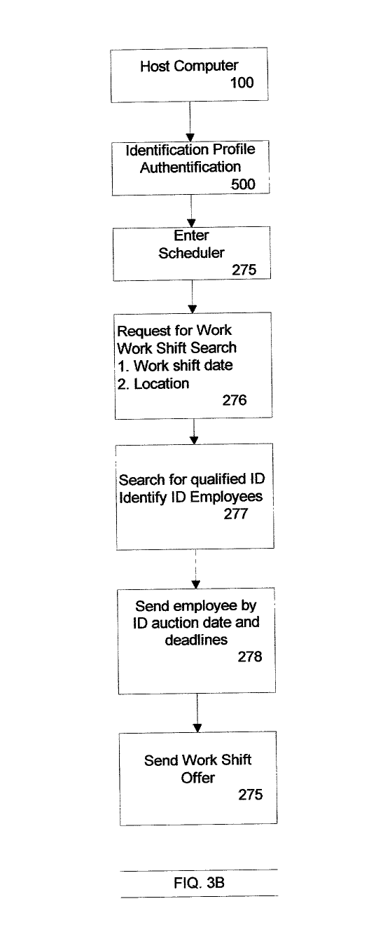

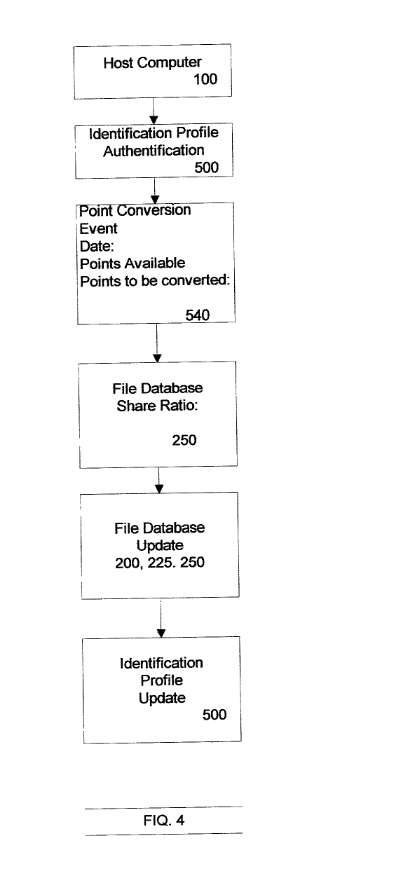

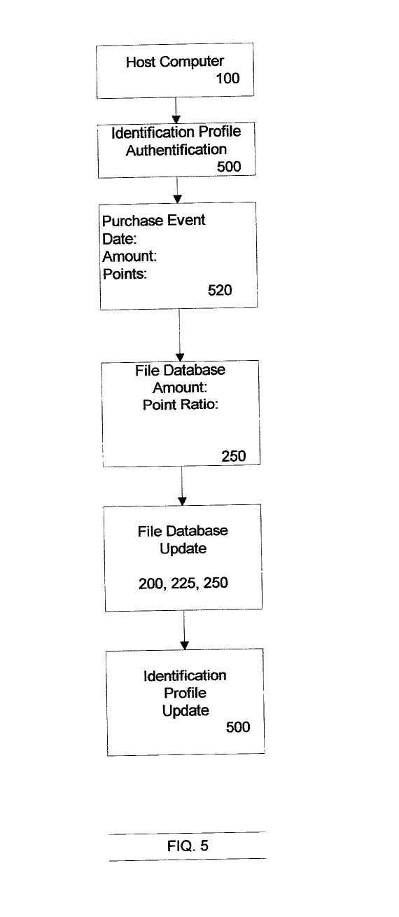

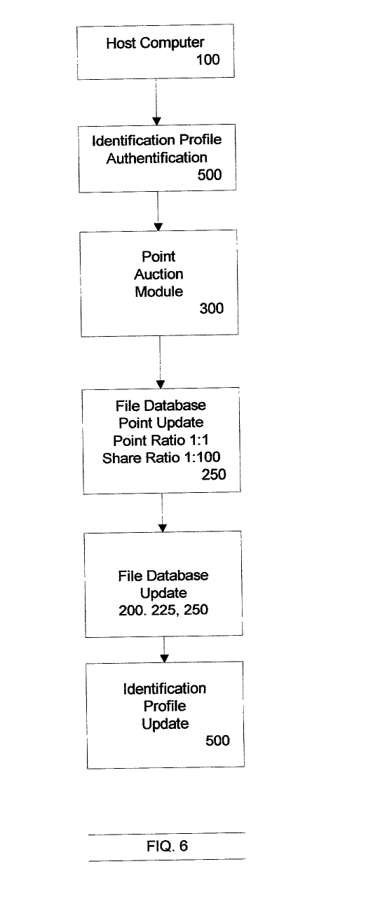

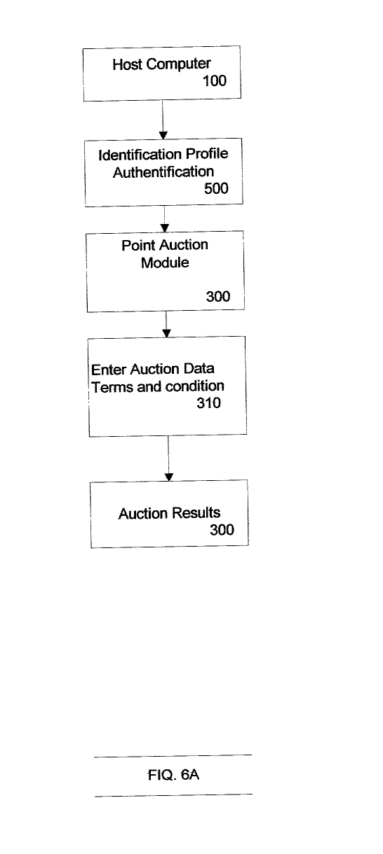

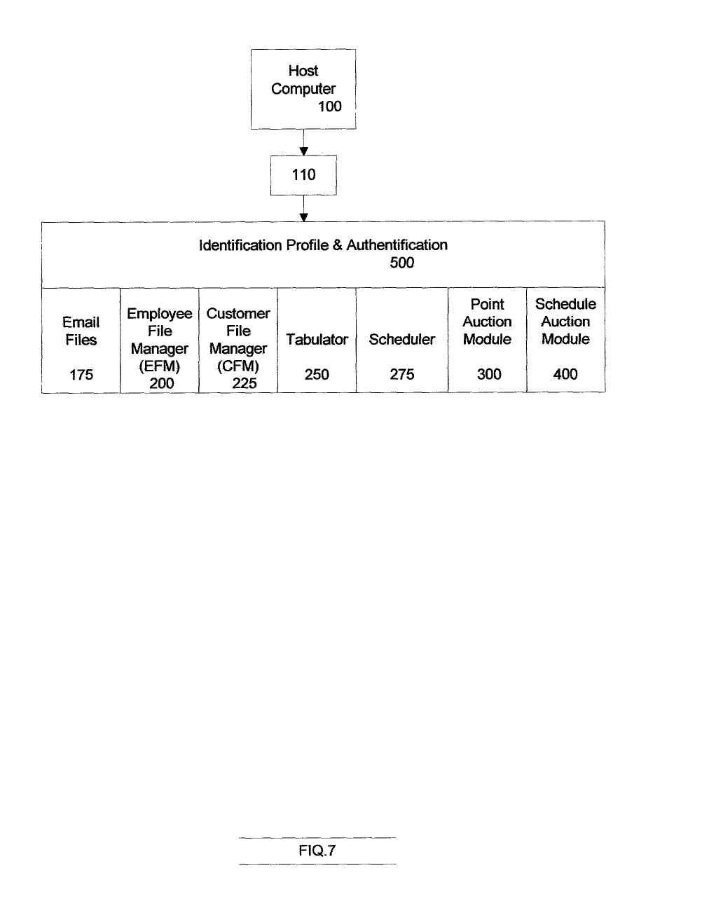

### FIELD OF TECHNOLOGY

The present invention consists of the methods and apparatus for effecting communications between employees, and between employees and customers. Wherein individual gain is achieved through the use of empowerment and application tools such as auctions, scheduler, database, wherein the user receives incentive by points for value, and company ownership. The present invention provides employees with an opportunity to improve employment opportunities, obtain and increase in personal wealth by work efficiencies and an increase in customer attendance and sales.

### BACKGROUND OF THE INVENTION

Productivity can achieve greater gains by empowering employees with managerial responsibility. This is not new to manufacturing where Edward Deming's practices are used, but is a new concept for the service industries.

In a restaurant operation, for example, the raw materials are purchased, received, designed, developed or finished, presented for sale, invoiced, paid and reconciled in one place. The customer makes an electronic or physical contact, orders, accepts and pays for the food delivered at that same Unit. The employee makes an electronic or physical contact, receives a request for service or product and delivers the service or product at the Unit. Restaurant operations employ, train, order raw materials, receive and store inventory, prepare the food items for presentation, market, sell and deliver the finished product, collect information, collect payment and repeat the process with new and existing customers. The opportunity for profit improves if productivity tools and techniques are continuously created and/or refined to reduce missed opportunities.

Service industries employ part-time and full-time employees for their technical skill. Many employees are not trained. For example, the restaurant industry provides entry-level jobs as dishwashers, hostesses and busboys. The waiter and waitress provide the majority of the communication with the customer. Customer loyalty today is determined by the combination of location, product quality, price and service. Today, the employee's role is limited. He or she has the opportunity to market and sell only at point of sale. The system inherent in this invention postulates that the employee possesses the skills to develop strong relationships with the restaurant clientele. In other industries, commission sales people generate loyalty. Commission salespeople have an opportunity to repeat sales in retail stores, and brokers dominate the financial industry. Insurance, annuity, mutual funds, stocks and bonds are products sold frequently with the same clients. In the financial industry, phone solicitations and monthly statements increase customer contact. Internet Protocol has expanded customer relationships to the point where sales costs have been reduced and customer retention has been increased. The restaurant industry is one of many industries having the same opportunity, when the invention is integrated into operations.

Entertainment is a growing industry and Units are providing greater diversity in themes. Card rooms, casinos and video arcades with food and beverage services provide greater marketing opportunities and incentives for customer loyalty. There are now numerous customer incentive programs through which points are accumulated and exchanged for drink, food, products and services such as air travel. Electronic scanners and database management programs provided the information and storage needed to facilitate premium redemption.

### Definition

The status “employee” is defmed as a user who has recorded a subscription agreement, Federal and State labor requirements. The Subscription Agreement is the agreement between the company and the employee which the employee is entitled the use of the ISS. The employee is assigned an Identification Profile (ID) which the ID empowers the employee to exchange points and work shifts, and to access the customer database. Point rewards are adjusted to the level of work performed and the return for the work shift. There is an employee classification which is a part of the ID. Each employee's performance is statistically measured and the measurement is and not limited to sales per Unit, return on equity per Unit, return on investment per Unit, cost per employee, Point Accumulation, Equity Accumulation and other measurements.

The term “Authentication” as used herein, encompasses multiple authentication schemes via Authentication Servers, LDAP Directory Servers, Firewall Secure Servers, Content Security, Virtual Private Network Appliances, and computers under the control of software for the purpose of authentication, protection against external and internal attacks, viruses, undesirable URL and more.

The term “Sponsor Company,” as used herein, encompasses any company that wishes to offer the ISS as an employee empowerment program and customer enhancement incentive program.

The term “Unit”, as used herein, encompasses any business facility, virtual facility, distribution center, broker, dealer, agent, retail store, restaurant, service center having the right to use the ISS.

The term “unit”, as used with points and shares is a item of value, an reward which is an option equal to a ratio of points to shares and can be converted to cash, and to share at a certain anniversary date.

The term “consumer,” as used herein, encompasses any individual or user who wishes to participate in awards or incentive programs offered by sponsor company and its units. Consumers may be employees of the sponsor company where the employee is working in a Unit, or may be customers of the sponsor company merchandise supplier.

The term “auction” as used herein encompasses any sponsor company transaction which include merchandise, points, equity shares and work shift schedules.

The term “server” as used herein encompasses a computer offering a service to another computer, which could be a dedicated machine, appliance server, application computer, email server, web server, web server software, database servers and client software.

The term “under the control of software components” as used to receive, send, direct, and route and not limited to transaction events, results, update, record, and store the data from and server, appliance, database or any type of computer system.

The term “Web server,” as used herein, encompasses any data processing system on which application programs and Internet sites may be stored for access and processing by Unit's computers. The Web server employs a customer relationship management application, control manager, web browser that allows for multimedia presentation of information, text, images, sound and video streaming.

An Integrated Service System (ISS) empowers employees to manage service operations. The Internet is vital and the employee in the ISS uses it to transfer information.

The term “value” as used herein is a unit or share of equity in a corporation. The unit or share is converted within the rules of Federal and State regulations. Value as used herein is a service or product, which is well known in the art of incentive programs. Airline rewards, merchandise award, and other promotions are used by business for loyalty programs.

The term “unit” as used herein is a portion of the Sponsored Companies outstanding equity or units. The unit is ownership in the Sponsored Company and or the unit is ownership which the unit will be converted to shares within an appointed anniversary.

### DETAIL DESCRIPTION OF THE DRAWINGS

FIQ. 1 is a schematic block diagram illustrating the different modules, databases controlled by the Server.

FIQ. 2 is a schematic block diagram of the Work Shift Event Module.

FIQ. 3 is the schematic block diagram illustrating the Work Shift Exchange Module.

FIQ. 3A is the schematic block diagram illustrating the Schedule Auction Module.

FIQ. 3B is a schematic block diagram illustrating the Scheduler.

FIQ. 4 is a schematic block diagram illustrating Point Conversion Event Module.

FIQ. 5 is a schematic block diagram illustrating the Purchase Event Module.

FIQ. 6 is a schematic block diagram illustrating the Point Exchange Module

FIQ. 6A is a schematic block diagram illustrating the Point Auction Module.

FIQ. 7 is a schematic block diagram of the server, modules and databases.

### SUMMARY OF THE INVENTION

A Unit is any business site (real or virtual) producing an item for sale or distribution. In the service industry, The Unit maybe, a department store, a specialty store, or a restaurant. A Unit may have as few as one individual with a book of clients and where the individual is employed by many different Units all separate and independent but linked to a sponsored companies (Sponsored Company) using the invention.

The invention provides customers with additional incentives by facilitating the acquisition of value by awarding points that can be converted at an appropriate ratio into units or equity shares. The invention further comprises the points to be exchanged for currency or points acquired for cash in an auction. Customer incentives are enhanced by his or her understanding of the point value of the holdings. The value is identified in the invention by the database Tabulator that is accessible to the customer. The Tabulator provides the explanation of points, units, shares, merchandise, and services.

The invention is an empowerment system that improves an employee's satisfaction and financial future by providing incentives for generating customer satisfaction and repeat business. The employee is given the opportunity to accept assignment for proprietary customer contact and to convert those customers to frequent clients. The customer purchases are events and are transaction events generating points. The points are converted to value using the invention where the customer has a choice of value. The company representative is the employee assigned to the customer and using the system, he or she can provide explanation. The ISS provides the employee with the support needed to succeed in that effort through a continuously updated customer profile and the employee can use a Customer File Manager Database (CFM).

Employees are empowered in each Unit to improve skills continuously. That skill development improves employee communication and success, and consequently, employee compensation, satisfaction and morale. For example, in department stores today, employees are not currently trained in the use of electronic mail, database file maintenance or other software tools. The present invention provides the system and infrastructure to assist in that skill development. With the acceleration of distance learning, Company learning programs can improve employee productivity. The current art allows measurement of employee productivity. Employee empowerment provides cost savings where such tools and training are provided for employee advancement within the Unit.

Customer satisfaction increases when the Unit employees use the data in the ISS to acknowledge customer preferences when they communicate telephonically, electronically and at the point of sale. Department store sales will be increased when employees can easily mine preference data stored reflecting previous purchases.

The Internet and other distributed networks provide efficient communication to the customer from the employee and employee to employee, collaborating, using peer to peer technology. The ISS provides the structure to send messages, the files to personalize the message from a database and the record of the message and its response. The customer uses the Internet to access the company Web site by a host computer for news and information, using a proprietary ID which is secure, and the empowerment modules (Auction Module) at which points are exchanged.

The ISS uses Customer Relationship Management tools to email customer alerts regarding promotions, point values, equity valuation, special events and company news. E-mail is a valuable tool that, when used effectively, can help the employee build customer loyalty and increase transaction events. In a specific industry as retail, department stores use personal shoppers, commission sale people who write or call customers when new merchandise is available or when existing merchandise is placed on sale.

Employee empowerment through application of the ISS creates considerable cost savings. The Unit's management role typical in service industries today is limited or eliminated through application of the ISS. For example, in a restaurant, the skilled employee with the highest employee classification provides any daily management decision making for the Unit. Those with the highest employee classifications will have achieved high levels of skills important to the Unit. In a restaurant for example, the employee in charge will have achieved through operating experience, an understanding of accounting, waitperson coverage limitations, cooking and other food preparation, restaurant purchasing, equipment supply and maintenance. The ISS empowers employees to make both front and back of the house management decisions in this specific operation. The employee in charge has achieved the levels of important skills at the Unit. These employees replace full time managers.

The invention provides the employee the management of work schedules wherein the employee uses the work shift module, Scheduler and the Schedule Auction. A Scheduler identifies employee work shifts and empowers employees to trade or auction work shifts with other work shift users. The invention encourages empowerment and effects the change furthering the decrease of management supervision.

The Scheduler is the system's database that provides real time information regarding work shift availability for the employee. Seasonal and cyclical demand creates stress in the retail industry, transportation, and housing. The System adjusts the demand for work shifts to reflect seasonal and holiday occupancy and retail sales peaks, high delivery demand periods, and weak or strong weekend traffic or occupancy.

Outsourcing labor is a growing business and the demand for qualified workers is accelerating. The healthcare service industry provides home health services through which skilled nurses provide the home treatments. Eighty percent of healthcare can be accomplished by a registered nurse. The Sponsored Company can provide long-term employment with wealth accumulation and it may have better efficiencies than the current operating ratios in the marketplace.

For example, in the restaurant and hospitality industry today, shift changes are most often the responsibility of the manager. Utilizes the ISS, an employee agrees to work for a Unit, he or she accepts the obligation to fulfill the work shifts assigned and to use the Scheduler and the Schedule Auction to exchange shifts for shifts or shifts for points. The point system provides additional incentive to negotiate since certain shifts may be more attractive from the perspective of creating return in equity or points per shift. To again use the restaurant industry as an example, exchanging a holiday shift will likely require the employee wishing to have the time off to offer a premium in points to the employee who agrees to work the shift. Work shifts are viewed as opportunities to acquire points and improve the employee customer accounts, revenue classification rating and equity. Or aggressive employees whose families are away may choice to work holiday and he or she may want to post a reverse auction, buyer's auction.

Auction tools are used in current applications to place merchandise up for bids and allowing buyers to bid against each other for the item. Overstock, used merchandise and unique items are sold in this format. Auction are used because these items are hard to price. An auction opens the transaction dynamically and, after some period of time has elapsed, the item is sold to the highest bidder. The Scheduler Auction is an application through which the employee has the opportunity to acquire not merchandise, but instead additional work shifts as determined by the terms agreed to through an auction process which the auction process is well known in the art.

Use of Auction on NASDAQ is negotiated. Market Makers who are regulated create the buy and sell side. Markets become more efficient as volume is increased and the spread between the bid and offer narrows. Points which are earned by users have an assigned value. For every point, there is a ratio divided into a share of the Sponsored Company. Points are negotiated in an auction between members and value is created when ownership shifts from points to equity or points to product acceptance.

The ISS helps to empower employees by offering the incentives designed to help the employee gain greater levels of producing customer satisfaction, loyalty and retention, managerial skills, business negotiation ability, database management, e-mail and an understanding of business valuation.

The Employee Subscription Contract is the agreement between the company and the employee that provides the employee the ISS. The employee Identification Profile empowers the employee to exchange points and work shifts, and to access the customer database. Point rewards are adjusted to the level of work performed and the return for the work shift. There is an employee classification, which is a part of the ID. The employee is encouraged to continuously improve using the ISS. The performance of each employee measured by sales per Unit, return on equity per Unit, return on investment, work shift days, point accumulation, equity accumulation. The transaction events are based upon the subscription agreement and the employee ID is updated in the invention.

The Customer Subscription Agreement is a binding contract. Its purpose is to bind the customer to the rules of the Sponsored Company. The terms and conditions are the membership requirements. The customer agrees to provide the information needed to allow the issuance of points, units and equity and/or the exchange of points, units and equity. The Agreement is inclusive and the points and equity exchanges are exclusive and can only be exchanged within the Sponsored Company's Point Auction. Points and equity can not be transferred or sold without the approval of the Sponsored Company, and in accordance with the laws governing securities and restricted shares. The transaction events are based upon the subscription agreement and the customer ID is updated in the invention.

ID enables empowerment by profiling the employee. This empowerment enables to exchange points, exchange work shifts, and access the database. Point rewards are adjusted to the level of work classification. The employee can be obligated to continuously improve using the ISS. The ISS through its database has the data for all employees and each employee is statistically measured by sales per Unit, return on equity per Unit, return on investment, point accumulation, share accumulation.

When points are converted to units or to shares of Sponsored Company shares outstanding, customer loyalty could be enhanced by the customer nature of ownership in the business.

### Description of the Preferred Embodiment

In this section, the present invention is described in detail with regard to the drawing described in Detail Description of the Drawings. Terms used throughout the remainder of this section are used with the meanings under Definitions.

The following paragraphs illustrate the structural and operational aspects of the preferred embodiment of the present invention.

In the embodiment the present invention provides the user access in the engagement of value creation. User's value is created by user transactions based upon the terms and conditions of a subscription agreement. The transaction events are essential and nonessential products, services and employment. The system provides the structure and operational aspects of the present invention for the user incentive and incentive enhancement for life long accumulation of essential, nonessential products, services and employment.

In FIQ 1, the system using a Host Computer 100, which is the preferred embodiment of the invention, the system is an IBM PC compatible operating the Microsoft Windows 2000 operating system, and the Server System 150 configured as a Web Server providing access. The Host Computer 100 software using Netscape Communicator or Microsoft Internet Explorer, the PC is capable of accessing the system, which is composed of web pages, which is well known in the art.

FIQ 1 shows a diagram of the system for user incentive transaction events in accordance with the preferred embodiment of the present invention. The system is not limited and an APPLE Macintosh system or a more advance computer system such as an Alpha based computer system available from COMPAQ Computer Corporation or SPARC station computer system available from SUN Microsystems, Corp. may be used. “Unit” terminals using scanning techniques which systems and methods are well known in the art provide a business with a local Host Computer.

Preferable the communication channel 110 is TCP/IP based network such as the Internet or an intranet, although almost any well known LAN, WAN, VPN technology can be used. Users can exchange messages with enclosures such as files, graphics, video and audio. The system also supports multiple languages. Alternatively, network interface may be configured as voice and voice over IP.

The System Server 150 is typically a Web server hardware and it can range from a high end PC to racks of multiprocessor, high-end computer system optimized for the task. Web server software can be Apache Web Server, Microsoft Internet Information Server, iPlanet Enterprise Server, IBM/Lotus Domino.

The BEA WebLogic Server and WebLogic Enterpise is the preferred embodiment. The WebLogic Server is a Java-based and EJB-compliant application server. WebLogic Enterprise is based on Tuxedo and CORBA. It is available for Compaq Tru64, UNIX, HP-UX, IBM AIX, IBM OS/400, Linux, SGI Irix, SiemensReliant UNIX, Sun Solaris and Windows NT. The supported databases are Informix, Microsoft SQL Server, Oracle and Sybase, where optimized JDBC drivers are provided and distributed transaction are based on the Java Transaction API standard. While the above embodiment describes a single computer acting under the control of software, those skilled in the art will realize that the functionality can be distributed over a plurality of computers. The diagram in FIQ 7 identifies the Server applications supporting the transaction events on a single system. The system can be distributed over a plurality of computers in a distributed architecture wherein the databases and processors are housed in separate locations. Each location is attached to a WAN which serves as a primary communication link with other locations, servers. Those skilled in the art understand, there is an unlimited number of locations, servers, that can be connected and supported.

FIQ. 1 the system provides the user, the access using a Host Computer 100 by a user Identification Profile 500 when the user has been authenticated by the Server 150. Authentication is the verification of a user's claimed identity which is the user logs into the system which is well known in the art. A password is the preferred embodiment where the user can access the system. The user has a Public Key Identification where the PKI is stored a server database. The user PKI includes the subscription agreement which includes the users name, address, phone number, email address, inception date and user classification. There are authentication structures as Pretty Good Privacy, X.500, x.509 and someone well know in the art can appreciate other methods and systems.

The server under the control of software components creates transaction events for reward enhancement. The transaction events are user requirements based upon a user subscription agreement which the agreement requirements define user incentives. A Purchase Event 520, Point Conversion Event 540, Point Exchange Event 560, Work Shift Event 580, and Work Shift Exchange Event 600 are recorded and stored in the file databases in the Server. The user Identification Profile is updated by each transaction event.

The Identification Profile (ID) is created by the initial transaction event and by executing the user subscription agreement. The ID is updated by the system at each transaction event. J. Galt is a user wherein J. Galt has completed a subscription agreement on Jan. 15, 2001 and J. Galt has entered into an employment agreement with a purchase of $100. J. Galt employment position is coded as ABC (ID: 01-1/100/ABC/JG. On April 15, J Galt has accumulated 5,000 points through work shifts and product purchases (ID: 01-1/5000/ABC/JG). On September 30, J. Galt has accumulated 10,000 points through work shifts and product purchases. J. Galt elects to convert ½ of the 10,000 points to units or shares value at a ratio of 1:100 and a current market price of $5.00 per unit or per share (ID: 01-1/5000/50/ABC/JG). On October 15, J. Galt job code has changed and the new classification BCD and from September 30 to October 15, J. Galt was awarded 500 additional points (ID: 01-1/5500/50/BCD/JG). The ID provides a record for the user and the user record of existing points, units, shares are within the ID, known to the user. Record of the value of said points, units, shares are recorded and stored in the system database known as the Tabulator. Value is known on each transaction event.

FIQ. 2 is a schematic block diagram of the Work Shift Event wherein the diagram describes the system recording the employee work shift event. The user is awarded points for completing a work shift 580. The “Unit” assigns a value to each work shift which the employee is awarded a certain amount of points. The award in points depends upon the employee productivity and the “Unit” productivity. The work shift date and points are the transaction event and the event is recorded in the file database with the reward amount. The ID is updated user 500 is update and the user file 200, 225 is stored in the database 250.

The system provides user account values known in the Tabulator Database 250 wherein all transaction events are of point, unit and share transactions are stored. The Ratio is stored in the Tabulator. The Ratio provides the exchange value of points to units and to shares.

FIQ. 3 is a schematic block diagram of the Work Shift Exchange Event 600 wherein a user employs a Scheduler 275 for work shift scheduling data, and a Schedule Auction Module 400 for exchanging work shifts. The Scheduler provides the Schedule Auction Module with the inquiry of a work shift exchange date. The Schedule Auction Module based upon the ID 500 executes the exchange between bidder and seller and the bidder and seller point exchange. The user ID is updated and stored in the database.

FIQ. 3A is a schematic block diagram of the Scheduler Auction 400 wherein the Schedule Auction Module which is well known in the art. The user schedule data is provided by the Scheduler (FIQ. 3B) wherein the user enters the terms and conditions of the work shift offer. Therefore the seller receives bids from users which the system has qualified and notified based upon the ID. The Auction Result 400 is sent to the Work Shift Exchange Module 600. The preferred auction platform is Oracle 81 Marketplace Platform. The example in FIQ. 3 is a forward auction which is well known in the art consisting of a seller accepting buy bids from multiply buyers. The winning bid is usually the bid with the highest value. The process of the exchange is well known wherein the buyer or seller request is processed, selected by either buyer or seller and accepted. Reverse auctions are now common in the art which the system user is a buyer wishes to buy a work shifts and the buyer issues a request for quote (RFQ) to a large number of employees who are sellers.

FIQ 3B is a schematic block diagram of the Scheduler 275. The preferred embodiment application is Simplex eFORCE that automatically generates and sorts employee work schedules by classification enterprise-wide. A user from a host computer 100 request for work shift search 276 defining the date and location of the work shift. The Scheduler identifies employee 277 by the ID and employee availability. Other schedulers as Kronos Smart Scheduler which workforce management is well known in the art can generate and sort work shift candidates. The user offering a request for a specific work shift change and the Scheduler identifying qualified work shift users based on the ID and the employee schedule. The Scheduler provides a list of qualified employee 278 and sends the list to the email directory or email server for employee notification, wherein the email has the work shift auction date, terms and conditions. The Scheduler sends the request of the Work Shift Offer to the Work Shift Exchange Event Module (FIQ. 3).

FIQ 4 is a schematic block diagram of the Point Conversion Event Module wherein the points are converted to units or shares and units or shares are issued to the user by the sponsored company. The user converts available points by the Point Conversion Event Module 540 using the Tabulator's 250 Ratio. The Tabulator has the ratio of points to unit or share price and in this example it is 100 points for 1 share where 1 share equals 5 dollars) and the Point Conversion Event is recorded in the databases and the user ID is updated.

FIQ 5 is a schematic block diagram of the Purchase Event Module wherein the user using the Host Computer 100 accesses the system based upon an ID. The purchase event 520 is a purchase of a product or service by credit card or currency that is well known in the art.

The preferred embodiment of the Purchase Event Module uses payment mechanisms in a “Unit” through a secured use of an existing credit and debit-card payment infrastructure which is readily apparent to those skilled in the art. The linking from the server or a processor connected to the server with a credit card clearinghouse or other authority. Non-Credit-Card and other methods using electronic cash such as CyberCoins and DigiCash which are stored on a smart card such as Mondex and Visa Cash are well known in the art. The process known as SSL developed by Netscape is a de facto standard for encrypting data sent between a user' browser and the merchant server. Business to business purchases over the Internet is aimed at organizations buying and selling over the Internet using OBI; Open Buying On The Internet. The architecture is designed for a Requisitioner, Buying Organization, Selling Organization and Payment Authority. The Purchase Event Module is the transaction event between the buyer and the seller.

The purchase has a known value and amount wherein the amount is awarded to the user. The amount is converted by the Point Ratio which the ratio is stored in the Tabulator database. The event is filed and stored in the database. The ID is updated.

FIQ 6 is a systematic block diagram of the Point Exchange Event Module 560 wherein a user can exchange points using the Point Auction Module 300 which is well known in the art. The user having an ID can exchange points with other users having an ID 500. The point exchange is recorded in the file and stored in the databases 200, 225. The Ratio is stored in the Tabulator and the points are update in the Tabulator 250. The ID is updated.

FIQ 6A is a systematic block diagram of Point Auction 300 wherein the auction is well known in the art. The user can exchange points by entering data on the Point Auction Module 300. The user may want to buy or sell points. The event is an exchange of points for cash, points for product, points for service. There is a buyer and a seller using the ID. The Auction Results are sent to the Point Exchange Event Module. The preferred embodiment is Oracle 81 Exchange Marketplace Platform, wherein the user is a qualified bidder or seller of points, units and equity. The auction platform is an e commerce tool that is well known in the art. The auction use in the preferred embodiment is a seller auction where points are offered. Reverse auctions are used which is a buyer wishes to sell points and the buyer issues a request for quote (RFQ) to a large number of sellers. The optimal bid is usually the highest point value.

FIQ 7 is a systematic block diagram of the Integrated Service System. The Host Computer 100 wherein is remote or in the “Unit”. The Host Computer can be wireless, wireline and it is connected to the Server and the user gains access by the Identification Profile. The server wherein is a computer process unit, web server or central processing unit wherein the computer is in the control of software components directing modules, and databases. Email File 175 are storage files of all users using electronic mail and the preferred embodiment is Critical Path's InScribe. The directory has a list of employees which the directory is controlled by ID. This enables the “InScribe Email Message and Message Boards communication of auction for both work shift, points and equity.

There are three databases and the preferred database embodiment is Oracle 9i. The Employee File Manager 200 wherein all employee records are stored, Customer File Manager 225 wherein all customer records are stored, and the Tabulator 250 wherein the point ratio, equity ratio, sponsored company share price and total points accumulated, and shares outstanding are stored. The Server's modules under the control of software components performs transaction events. The user events are recorded and stored in either the Employee File Manager 200, Customer File Manager 225 and point transactions updated in the Tabulator. Auction Module 300 provides the method of a point exchange or point exchange between users. The Schedule Auction Module 400 provides employee work shift exchanges and employee point exchanges. The Scheduler 275 provides work shift schedules for all work shift classifications. The employee can request a work shift change and the Scheduler can query available employees based upon job classification codes.

Therefore, the system uses transaction events to generate the user's incentives by a remote or onsite computer. The user's identification profile provides access to the server computer where the user ID is updated by the purchase of merchandise and services. The employee who is a user can be awarded value by completed work shift using the system. Furthermore, the user earns points and the user ID is updated by any point change. The point having value is converted into the system's sponsored company units or shares and the points have a certain ratio and the units have a certain unit price or stock price and the ID is updated. Customers and employees use the system to exchange the points to acquire more points or to exchange points for currency, products or services. Points are exchanged between two users where the users exchange by an auction. The auction module provides the exchange and it is recorded as a transaction event. The Scheduler is used when an employee wishes to change a work shift. The Scheduler provides the system with work shift and the method of selecting qualified users, which the system notifies, users by employee email. The employee bids on the work shift and there may be an exchange of a work shift and an exchange of points which the exchange is negotiated between two employees in the Schedule Auction Module. The ID is updated based on the user's transaction events of purchases, conversions, and exchanges, which are known by the user by executing the Sponsored Company subscription agreement. The user's transaction event are stored in the system's database known as the Customer File Manager for customer relationship management, the Employee File Manager for employee relationship management and the Tabulator for point conversion ratio, unit price, share price and point and shares outstanding.

It is claimed:

1. A system using transaction events to generate user incentives:
a host computer for transmitting a user identification profile:
a server computer under the control of software components, wherein the components comprise:
a transaction event module for generating points based upon a transaction event.
a Point Exchange Module for exchanging points;
wherein the server computer updates the identification profile based upon the transaction event or point conversion.

2. The system of claim 1, wherein the software components of the server computer further comprise, a Point Conversion Module for converting points to units.

3. The system of claim 1, wherein the Point Exchange Module exchanges points for a
value” selected from the group consisting of equity, cash, product and services.

4. The system of claim 1, wherein the Point Exchange Module further comprises a Point Auction Module for selling or purchasing points.

5. The system of claim 1, further comprises a Work Shift Module wherein the employee exchanges work shifts.

6. The system of claim 1, further comprises a Work Shift Exchange Module wherein the employee exchanges work shifts.

7. The system of claim 6, further comprises a Scheduler wherein the Scheduler identifies employee work shift availability.

8. The system of claim 6, further comprises a Schedule Auction Module wherein the employees can exchange work shifts wherein each work shift exchange represents a certain point value.

9. The system of claim 1, wherein the database further comprises three databases the Employee File Manager, Customer File Manager and the Tabulator for employees, customers and point data storage.

10. The system in claim 1, comprises an Identification Profile (ID) wherein the ID is based upon a subscription agreement.
